(19) United States
(12) Patent Application Publication
(10) Pub. No.: US 2026/0163035 A1
(43) Pub. Date: Jun. 11, 2026

(54) FUEL CELL APPARATUS AND METHOD OF CONTROLLING THE SAME

(71) Applicants: HYUNDAI MOTOR COMPANY, SEOUL (KR); KIA CORPORATION, SEOUL (KR)

(72) Inventors: Sang Hoon Ahn, Hwaseong-si (KR); Hee Sung Yoon, Hwaseong-si (KR); Hyo Chang Choi, Hwaseong-si (KR)

(73) Assignees: HYUNDAI MOTOR COMPANY, SEOUL (KR); KIA CORPORATION, SEOUL (KR)

(21) Appl. No.: 19/210,364

(22) Filed: May 16, 2025

(30) Foreign Application Priority Data
Dec. 10, 2024 (KR) 10-2024-0183032

(51) Int. Cl. H01M 8/04858; H01M 8/0438

(52) U.S. Cl. CPC H01M 8/0488; H01M 8/04388

(57) ABSTRACT

A fuel cell apparatus includes: a fuel cell unit configured to generate a first voltage; a battery configured to store a second voltage having a higher level than the first voltage; a first voltage level conversion unit configured to boost the first voltage and supply the boosted voltage to the battery in response to a first control signal; a second voltage level conversion unit configured to step down the second voltage and supply the stepped-down voltage to the fuel cell unit in response to a second control signal; and a controller configured to generate the first control signal and the second control signal in response to a start command or a stop command.

### CROSS-REFERENCE TO RELATED APPLICATION(S)

This application claims the benefit of and priority to Korean Patent Application No. 10-2024-0183032, filed on Dec. 10, 2024, which is hereby incorporated by reference as if fully set forth herein.

### BACKGROUND

### Technical Field

Embodiments relate to a fuel cell apparatus and a method of controlling the same.

### Discussion of the Related Art

Fuel cell apparatuses that produce high output are desired in many applications. Thus, in industry, a method of connecting a plurality of fuel cells in parallel is being attempted. However, when fuel cells are connected in parallel, the overall insulation resistance of a fuel cell apparatus greatly decreases. As the insulation resistance decreases, the possibility of causing electric shock to a user increases. Therefore, it is desired to secure insulation resistance.

Examples of technology for securing insulation resistance of a fuel cell apparatus include control detection of reduction in insulation resistance and recovery of the insulation resistance, limit of the power range of a fuel cell DC/DC converter (FDC), and management of the ionic conductivity of coolant. These technologies are effective for one fuel cell or in connecting a small number of fuel cells in parallel. However, in the case of connecting a large number of fuel cells in parallel, the above technologies have limitations in resolving the extent to which insulation resistance is reduced.

Another method of securing the insulation resistance of a fuel cell apparatus is to employ a bidirectional insulated FDC capable of receiving sufficient power. However, the bidirectional insulated FDC is very difficult to develop and thus can hardly be commercialized. Therefore, there is a desire to solve the above mentioned technical problems.

### SUMMARY

Accordingly, embodiments are directed to a fuel cell apparatus and a method of controlling the same that substantially obviate one or more technical problems due to limitations and disadvantages of the related art.

Embodiments provide a fuel cell apparatus that is inexpensive and has excellent insulation properties and a method of controlling the same.

However, the objects to be accomplished by the embodiments are not limited to the above-mentioned objects, and other objects not mentioned herein should be clearly understood by those having ordinary skill in the art from the following description.

Additional advantages, objects, and features of the disclosure are set forth in part in the description which follows and in part should become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

A fuel cell apparatus according to an embodiment may include: a fuel cell unit configured to generate a first voltage; a battery configured to store a second voltage having a higher level than the first voltage; a first voltage level conversion unit configured to boost the first voltage and supply the boosted voltage to the battery in response to a first control signal; and a second voltage level conversion unit configured to step down the second voltage and supply the stepped-down voltage to the fuel cell unit in response to a second control signal. The fuel cell apparatus may also include a controller configured to generate the first control signal and the second control signal in response to a start command or a stop command.

In an example, the first voltage level conversion unit may include an insulated unidirectional boost converter.

In an example, the second voltage level conversion unit may include an insulated unidirectional buck converter.

In an example, the second voltage level conversion unit may include a non-insulated unidirectional buck converter.

In an example, the fuel cell apparatus may further include a main switching unit configured to interrupt or allow electrical connection between the second voltage level conversion unit and the fuel cell unit in response to a first switching signal.

In an example, the first voltage level conversion unit may include a first input side connected to the fuel cell unit and a first output side connected to the battery. The second voltage level conversion unit may include a second input side connected to the fuel cell unit and a second output side connected to the battery.

In an example, the fuel cell unit may include first to N^{th} fuel cell units configured to respectively generate 1-1^{st} to 1-N^{th} (N being a positive integer greater than or equal to 2) voltages. The controller may generate 1-1^{st} to 1-N^{th} control signals as the first control signal and may generate 2-1^{st} to 2-N^{th} control signals as the second control signal. The first voltage level conversion unit may include 1-1^{st} to 1-N^{th} voltage level conversion units. The second voltage level conversion unit may include 2-1^{st} to 2-N^{th} voltage level conversion units. A 1-n^{th} (1≤n≤N) voltage level conversion unit may boost a 1-n^{th} voltage and may supply the boosted voltage to the battery in response to a 1-n^{th} control signal. A 2-n^{th} voltage level conversion unit may step down the second voltage and may supply the stepped-down voltage to an n^{th} fuel cell unit in response to a 2-n^{th} control signal.

In an example, the controller may determine the number of fuel cell units to be started or stopped simultaneously among the first to N^{th} fuel cell units in accordance with an insulation resistance value.

In an example, the n^{th} fuel cell unit may include: a cell stack configured to generate a 1-n^{th} voltage; a peripheral auxiliary device configured to aid in operation of the cell stack; and a sub-switching unit connected between each of the 1-n^{th} and 2-n^{th} voltage level conversion units and the cell stack. The sub-switching unit is configured to be switched in response to a 2-n^{th} switching signal. The n^{th} fuel cell unit may also include a diode having an anode connected to the cell stack and a cathode connected to the sub-switching unit.

In an example, the controller may switch the sub-switching unit using the 2-n^{th} switching signal to stop or start the n^{th} fuel cell unit.

According to another embodiment, a method of controlling a fuel cell apparatus is provided. The fuel cell apparatus includes: a fuel cell unit configured to generate a first voltage; a battery configured to store a second voltage having a higher level than the first voltage; a first voltage level conversion unit configured to boost the first voltage and supply the boosted voltage to the battery; and a second voltage level conversion unit configured to step down the second voltage and supply the stepped-down voltage to the fuel cell unit. The method may include: determining whether to start the fuel cell unit or to stop the fuel cell unit; starting the fuel cell unit using the second voltage level conversion unit upon determining to start the fuel cell unit; and stopping the fuel cell unit using the second voltage level conversion unit upon determining to stop the fuel cell unit.

In an example, the fuel cell unit may include a cell stack configured to generate the first voltage and a peripheral auxiliary device configured to aid in operation of the cell stack.

In an example, starting the fuel cell unit may include: connecting an input side of the second voltage level conversion unit to an output side of the fuel cell unit to start the fuel cell unit; holding a boosting operation of the first voltage level conversion unit in a standby state; and performing a stepping-down operation of the second voltage level conversion unit until a voltage of the input side of the second voltage level conversion unit reaches a second target voltage. Starting the fuel cell unit may also include: performing a process for generation of power by the fuel cell unit after the voltage of the input side reaches the second target voltage and until the first voltage reaches the second target voltage and the fuel cell unit enters a state capable of generating power; and stopping an operation of the second voltage level conversion unit after the fuel cell unit enters the state capable of generating power and until the first voltage reaches a first target voltage of an input side of the first voltage level conversion unit. Additionally, starting the fuel cell unit may include interrupting the connection between the input side of the second voltage level conversion unit and the output side of the fuel cell unit when the first voltage reaches the first target voltage.

In an example, stopping the fuel cell unit may include fixing a voltage of the input side of the first voltage level conversion unit and performing the stepping-down operation of the second voltage level conversion unit until the voltage of the input side of the second voltage level conversion unit reaches the second target voltage to stop the fuel cell unit. Stopping the fuel cell unit may also include connecting the input side of the second voltage level conversion unit and the output side of the fuel cell unit to each other when the voltage of the input side of the second voltage level conversion unit reaches the second target voltage. Stopping the fuel cell unit may also include: interrupting the connection between each of the first and second voltage level conversion units and the cell stack when the first voltage reaches the second target voltage; performing a process to stop generation of power by the fuel cell unit until the first voltage is consumed; performing a subsequent process to stop generation of power by the fuel cell unit when the first voltage is consumed; stopping operations of the first and second voltage level conversion units; and interrupting connection between the input side of the second voltage level conversion unit and the output side of the fuel cell unit.

It should be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a block diagram of a fuel cell apparatus according to an embodiment;

FIG. 2 is a block diagram of an embodiment of a fuel cell unit shown in FIG. 1;

FIG. 3 is a block diagram of an embodiment of the fuel cell apparatus shown in FIG. 1;

FIG. 4 is a flowchart of an embodiment explaining a method of controlling a fuel cell apparatus according to an embodiment;

FIG. 5 is a flowchart explaining an embodiment of step 340 shown in FIG. 4;

FIG. 6 includes waveform diagrams explaining step 340A shown in FIG. 5;

FIG. 7 is a flowchart explaining an embodiment of step 350 shown in FIG. 4;

FIG. 8 includes waveform diagrams explaining step 350A shown in FIG. 7;

FIGS. 9A and 9B are block diagrams of a fuel cell apparatus according to a comparative example;

FIG. 10 includes timing diagrams explaining a start operation of a fuel cell apparatus according to the comparative example of FIGS. 9A and 9B; and

FIG. 11 includes timing diagrams explaining a stop operation of the fuel cell apparatus according to the comparative example of FIGS. 9A and 9B.

### DETAILED DESCRIPTION

The present disclosure is described more fully hereinafter with reference to the accompanying drawings, in which various embodiments are shown. The examples, however, may be embodied in many different forms, and should not be construed as being limited to the embodiments set forth herein. Rather, these embodiments are provided so that this disclosure is more thorough and complete, and more fully conveys the scope of the disclosure to those having ordinary skill in the art.

It should be understood that when an element is referred to as being “on” or “under” another element, it may be directly on/under the element, or one or more intervening elements may also be present.

When an element is referred to as being “on” or “under”, “under the element” as well as “on the element” may be included based on the element.

In addition, relational terms, such as “first”, “second”, “on/upper part/above”, and “under/lower part/below”, are used only to distinguish between one subject or element and another subject or element, without necessarily requiring or involving any physical or logical relationship or sequence between the subjects or elements.

When a controller, component, device, element, part, unit, module, or the like of the present disclosure is described as having a purpose or performing an operation, function, or the like, the controller, component, device, element, part, unit, or module should be considered herein as being “configured to” meet that purpose or perform that operation or function. Each controller, component, device, element, part, unit, module, and the like may separately embody or be included with a processor and a memory, such as a non-transitory computer-readable media, as part of the apparatus.

Hereinafter, a fuel cell apparatus 100 according to an embodiment is described with reference to the accompanying drawings.

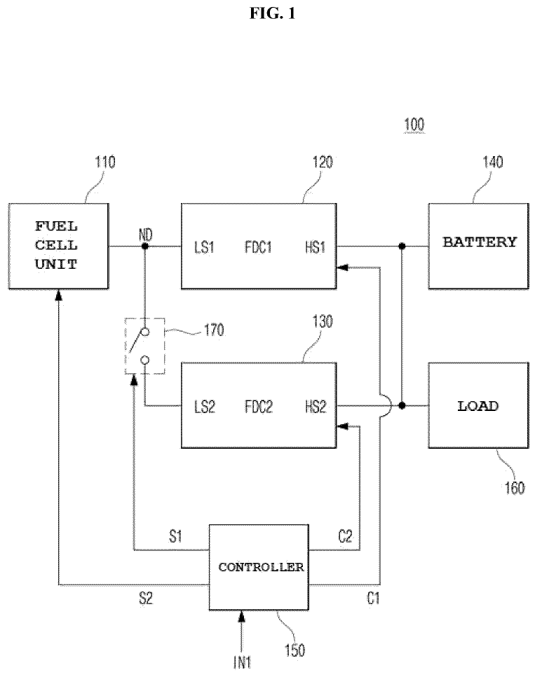

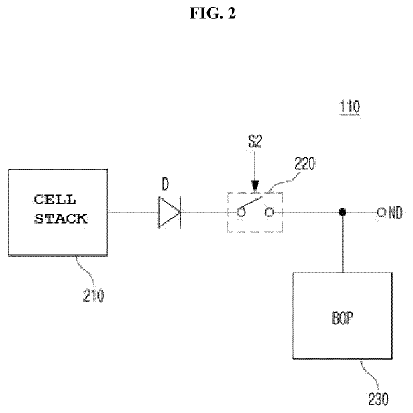

FIG. 1 is a block diagram of a fuel cell apparatus 100 according to an embodiment. FIG. 2 is a block diagram of an embodiment of a fuel cell unit 110 shown in FIG. 1.

The fuel cell apparatus 100 shown in FIG. 1 may include a fuel cell unit 110, first and second voltage level conversion units 120 and 130, a battery (or a high-voltage battery) 140, a controller 150, and a main switching unit 170. In addition, the fuel cell apparatus 100 may further include a load 160.

The fuel cell unit 110 may include a plurality of unit fuel cells stacked in at least one of a vertical direction or a horizontal direction. When the fuel cell apparatus 100 is a vehicle, the unit fuel cell may be a polymer electrolyte membrane fuel cell (or a proton exchange membrane fuel cell) (PEMFC), which has been studied most extensively as a power source for driving fuel cell vehicles. However, the embodiments are not limited to any specific form, configuration, or appearance of the unit fuel cell.

The unit fuel cell included in the fuel cell unit 110 may include end plates (pressing plates or compression plates) (not shown), current collectors (not shown), and a cell stack 210.

The cell stack 210 may include a plurality of unit cells stacked in the horizontal direction. Tens to hundreds of unit cells, for example, 100 to 400 unit cells, may be stacked to form the cell stack 210. The number of unit fuel cells included in the fuel cell unit 110 and the number of unit cells included in the cell stack 210 of the unit fuel cell may be determined depending on the intensity of power to be supplied from the fuel cell unit 110 to the load 160.

The end plates may be disposed at respective ends of the cell stack 210 and may support and fix the plurality of unit cells. In other words, one of the end plates may be disposed at one of the two opposite ends of the cell stack, and the other of the end plates may be disposed at the other of the two opposite ends of the cell stack.

In addition, the fuel cell unit 110 may further include a clamping member (not shown), which has a bar shape, a long bolt shape, a belt shape, or a rigid rope shape to clamp the plurality of unit cells. For example, in each unit fuel cell, the clamping member serves to clamp the plurality of unit cells in the horizontal direction together with the end plates.

Referring to FIG. 2, the fuel cell unit 110 may include a cell stack 210, a diode D, a sub-switching unit 220, and a peripheral auxiliary device (balance-of-plant (BOP)) 230.

The cell stack 220 serves to generate a stack voltage (hereinafter referred to as a “first voltage”).

The BOP 230 is an operating device for driving the fuel cell unit 110, and may include a compressor, a cooling pump, and a hydrogen supplier in order to aid in operation of the cell stack 210.

The sub-switching unit 220 is connected between a terminal ND, connected to each of the first and second voltage level conversion units 120 and 130, and the cell stack 210, and is switched in response to a second switching signal S2.

The diode D has an anode connected to the cell stack 210 and a cathode connected to the sub-switching unit 220.

The first voltage level conversion unit 120 may boost a first voltage generated by the fuel cell unit 110 in response to a first control signal C1, and may supply the boosted voltage to the battery 140 or the load 160. For example, the first voltage level conversion unit 120 may include a high-voltage boost DC/DC converter (or a fuel cell DC/DC converter (FDC)) (hereinafter referred to as an “FDC1”).

The FDC1 120 performs operation of matching the first voltage generated by the fuel cell unit 110 with the voltage stored in the battery 140 (hereinafter referred to as a “second voltage”). The second voltage has a higher level than the first voltage. For example, while the level of the first voltage is about 100 V to about 200 V, the level of the second voltage stored in the battery 140 is about 600 V to about 800 V. Thus, the FDC1 120 may operate as a type of boost converter that steps up the level of the first voltage to the level of the second voltage. In some cases, boost converters may be connected in parallel to implement the FDC1 120.

The FDC1 120 may include a first input side (or a low-voltage side) LS1 connected to the fuel cell unit 110 and a first output side (or a high-voltage side) HS1 connected to the battery 140.

The second voltage level conversion unit 130 may step down the second voltage in response to a second control signal C2, and may supply the stepped-down voltage to the fuel cell unit 110. For example, the second voltage level conversion unit 130 may include a high-voltage boost DC/DC converter (or a fuel cell DC/DC converter (FDC)) (hereinafter referred to as an “FDC2”). The FDC2 130 may operate as a type of buck converter that steps down the second voltage to, for example, 400 V.

The FDC2 130 may include a second input side (or a low-voltage side) LS2 connected to the fuel cell unit 110 via the main switching unit 170 and a second output side (or a high-voltage side) HS2 connected to the battery 140.

According to an embodiment, the FDC1 120 may include an insulated unidirectional boost converter, and the FDC2 130 may include an insulated unidirectional buck converter.

According to another embodiment, the FDC1 120 may include an insulated unidirectional boost converter, and the FDC2 130 may include a non-insulated unidirectional buck converter. In this case, as shown in FIG. 1, the fuel cell apparatus 100 may include the main switching unit 170.

The battery 140 serves to store the boosted first voltage output from the FDC1 120 and supply necessary power to the load 160. In addition, the battery 140 may supply the second voltage to the FDC2 130.

The controller 150 serves to control operations of the FDC1 120 and the FDC2 130. As is described below, the controller 150 may generate a first control signal C1 for controlling the FDC1 120 and a second control signal C2 for controlling the FDC2 130 in response to a start command for starting the fuel cell unit 110 or a stop command for stopping the fuel cell unit 110, which is received through an input terminal IN1. The start command or the stop command may be provided from an upper-level controller (not shown) to the controller 150.

The load 160 may include an inverter (not shown) and a motor (not shown). The inverter may be connected to the boosted voltage or the battery voltage, may convert DC voltage received from the FDC1 120 or the battery 140 into AC voltage in accordance with the driving state of the fuel cell vehicle, and may output the AC voltage to the motor. The motor may operate in response to the AC voltage output from the inverter. In other words, the motor may rotate in response to the AC voltage for the motor received from the inverter, thereby performing the function of driving the fuel cell vehicle. For example, the motor may be a three-phase AC rotating device that includes a rotor in which permanent magnets are embedded. However, the embodiments are not limited to any specific form of the main output unit, the inverter, or the motor.

The main switching unit 170 is connected between the FDC2 130 and the fuel cell unit 110, and performs a switching operation to interrupt or allow electrical connection between the FDC2 130 and the fuel cell unit 110 in response to a first switching signal S1.

The controller 150 serves to generate the first switching signal S1 and the second switching signal S2 in response to the start command or the stop command.

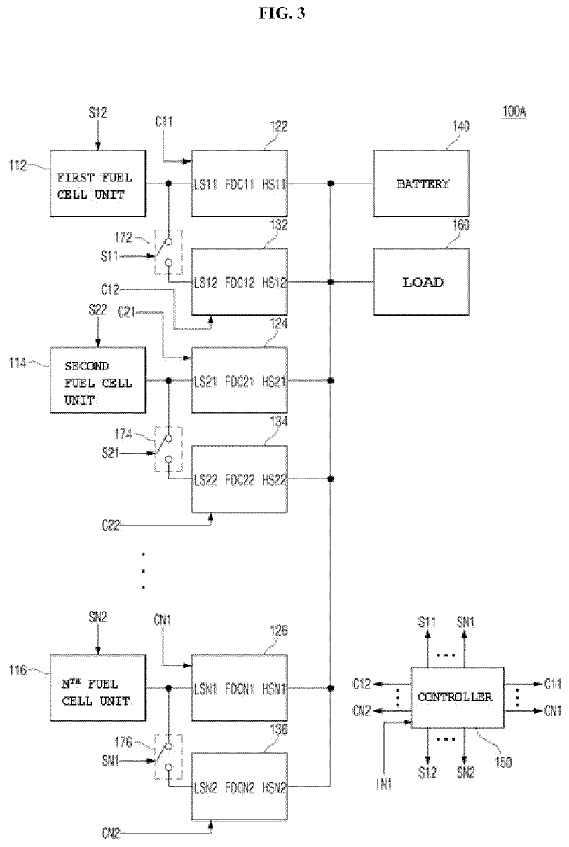

FIG. 3 is a block diagram of a fuel cell apparatus embodiment 100A of the fuel cell apparatus 100 shown in FIG. 1.

The fuel cell apparatus 100A according to another embodiment may include N fuel cell units 112, 114, and 116, N FDC1s 122, 124, and 126, N FDC2s 132, 134, and 136, a battery 140, a load 160, and a controller 150. N is a positive integer greater than or equal to 2.

Each of the first, second, . . . , and N^{th} fuel cell units 112, 114, . . . , and 116 shown in FIG. 3 performs the same function as the fuel cell unit 110 shown in FIG. 1. Each of the first FDC1 (FDC11), the second FDC1 (FDC21), . . . , and the N^{th} FDC1 (FDCN1) 122, 124, . . . , and 126 performs the same function as the FDC1 120 shown in FIG. 1. Additionally, each of the first FDC2 (FDC12), the second FDC2 (FDC22), . . . , and the N^{th} FDC2 (FDCN2) 132, 134, . . . , and 136 performs the same function as the FDC2 130 shown in FIG. 1. In addition, the battery 140, the load 160, and the controller 150 perform the same functions as the battery 140, the load 160, and the controller 150 shown in FIG. 1, respectively. Thus, a duplicate description of the same components has been omitted.

Referring to FIGS. 1 and 3 together, the fuel cell unit may include the first to N^{th} fuel cell units 112, 114, and 116, and each of the first to N^{th} fuel cell units 112, 114, and 116 generates a first voltage. Hereinafter, the first voltages generated by the first to N^{th} fuel cell units 112, 114, and 116 are referred to as 1-1^{st} to 1-N^{th} voltages.

The first voltage level conversion unit may include 1-1^{st} to 1-N^{th} voltage level conversion units (FDC11, FDC21, and FDCN1) 122, 124, and 126. The 1-n^{th} voltage level conversion unit FDCn1 may boost a 1-n^{th} voltage and supply the boosted voltage to the battery 140 in response to a 1-n^{th} control signal Cn1.

The second voltage level conversion unit may include 2-1^{st} to 2-N^{th} voltage level conversion units (FDC12, FDC22, and FDCN2) 132, 134, and 136. The 2-n^{th} voltage level conversion unit FDCn2 may step down the second voltage and supply the stepped-down voltage to the n^{th} fuel cell unit in response to a 2-n^{th} control signal Cn2.

Each of the first to N^{th} fuel cell units 112, 114, and 116, i.e., the n^{th} fuel cell unit, may have a configuration shown in FIG. 2. For example, 1≤n≤N.

Referring to FIG. 2, the cell stack 210 serves to generate the 1-n^{th} voltage, and the peripheral auxiliary device (BOP) 230 serves to aid in operation of the cell stack 210.

The sub-switching unit 220 is connected between each of the 1-n^{th} and 2-n^{th} voltage level conversion units FDCn1 and FDCn2 and the cell stack 210, and is switched in response to a 2-n^{th} switching signal S2.

The diode D has an anode connected to the cell stack 210 and a cathode connected to the sub-switching unit 220.

The battery 140 and the load 160 are the same as the battery 140 and the load 160 shown in FIG. 1, respectively, and thus a duplicate description thereof has been omitted.

The controller 150 may generate 1-1^{st} to 1-N^{th} control signals C11, C21, . . . , and CN1 as the first control signal C1, and may output the 1-1^{st} to 1-N^{th} control signals C11, C21, . . . , and CN1 to the 1-1^{st} to 1-N^{th} voltage level conversion units FDC11 to FDCN1, respectively. In addition, the controller 150 may generate 2-1^{st} to 2-N^{th} control signals C12, C22, . . . , and CN2 as the second control signal C2, and may output the 2-1^{st} to 2-N^{th} control signals C12, C22, . . . , and CN2 to the 2-1^{st} to 2-N^{th} voltage level conversion units FDC12 to FDCN2, respectively.

When intending to stop or start the n^{th} fuel cell unit, the controller 150 switches the main switching unit 172, 174, or 176 using a 1-n^{th} switching signal Cln and switches the sub-switching unit 220 using a 2-n^{th} switching signal C2n.

As shown in FIG. 3, when there are N fuel cell units 112, 114, and 116, N FDC1s 122, 124, and 126, and N FDC2s 132, 134, and 136, the controller 150 may determine the number of fuel cell units to be started or stopped simultaneously among the first to N^{th} fuel cell units 112, 114, and 116 in accordance with the insulation resistance value required by the fuel cell apparatus 100A.

Hereinafter, a method of controlling the fuel cell apparatus 100 or 100A configured as described above is described with reference to the accompanying drawings. For convenience of description, the control method according to the embodiment is described as a method of controlling the apparatus 100 shown in FIG. 1. However, the following description may also be applied to a method of controlling the apparatus 100A shown in FIG. 3.

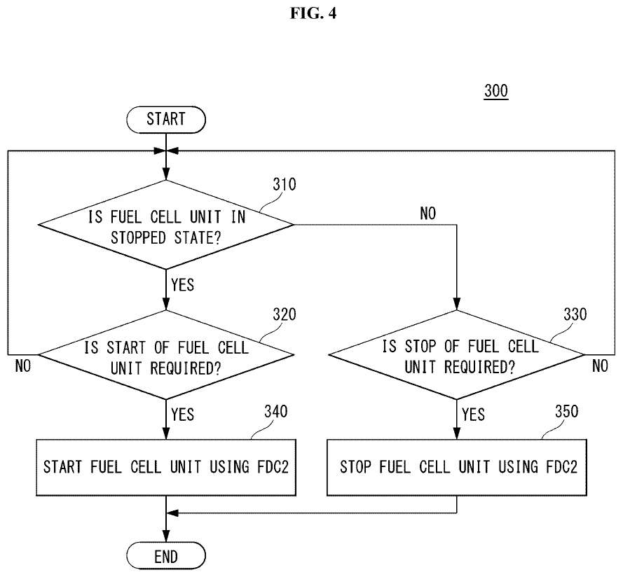

FIG. 4 is a flowchart of an embodiment explaining a method 300 of controlling a fuel cell apparatus according to an embodiment.

The method 300 of controlling the fuel cell apparatus includes determining whether start of the fuel cell unit 100 is desired or stop of the fuel cell unit 100 is desired (steps 310 to 330). Steps 310 and 330 may be performed by the controller 150. For example, upon receiving a start command through the input terminal IN1, the controller 150 may determine that start of the fuel cell unit 110 is desired. In addition, upon receiving a stop command through the input terminal IN1, the controller 150 may determine that stop of the fuel cell unit 110 is desired.

In detail, whether the fuel cell unit 110 is in a stopped state is determined (step 310). When the fuel cell unit 110 is in a stopped state, whether start of the fuel cell unit 110 is desired is determined (step 320). However, if the fuel cell unit 110 is not in a stopped state, whether stop of the fuel cell unit 110 is desired is determined (step 330).

When start of the fuel cell unit 110 is desired, the controller 150 controls the FDC1 120, the FDC2 130, and the main switching unit 170 to start the fuel cell unit 110 (step 340). However, when stop of the fuel cell unit 110 is desired, the controller 150 controls the FDC1 120, the FDC2 130, and the main switching unit 170 to stop the fuel cell unit 110 (step 350).

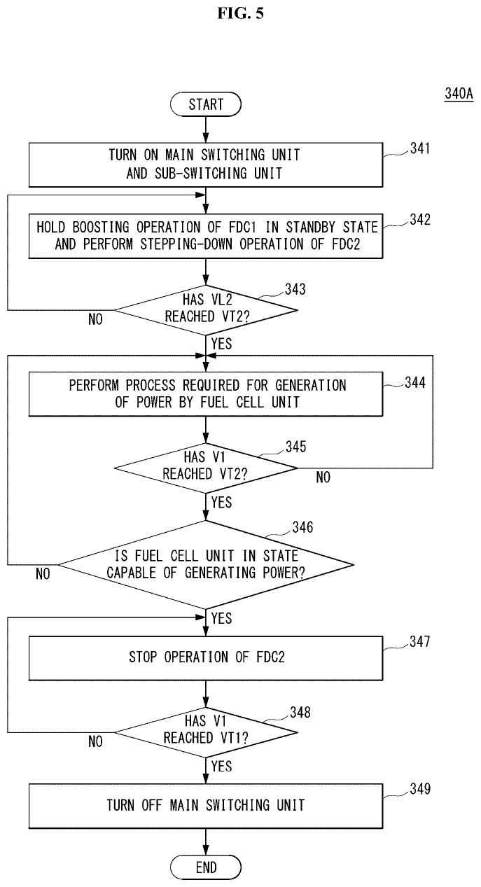

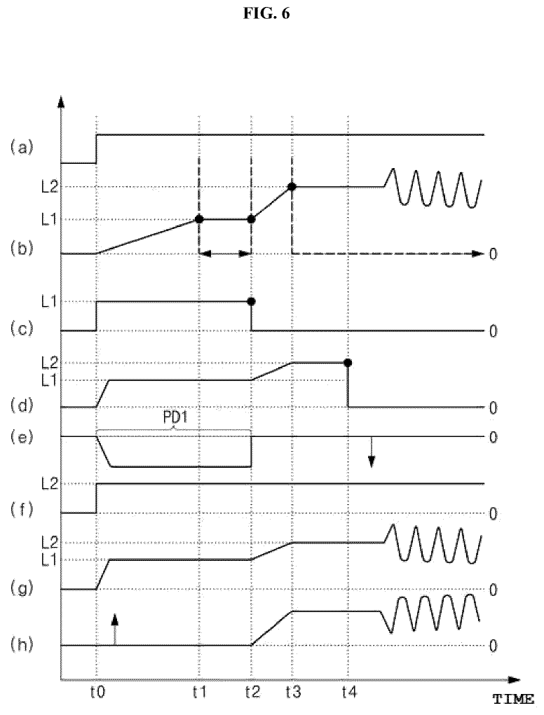

FIG. 5 is a flowchart explaining an embodiment 340A of step 340 shown in FIG. 4. FIG. 6 includes waveform diagrams explaining step 340A shown in FIG. 5. Diagram (a) of FIG. 6 indicates a start command. Diagram (b) of FIG. 6 indicates a first voltage. Diagram (c) of FIG. 6 indicates a voltage command of the FDC2 130, i.e., a target voltage VT2 of the input side LS2 of the FDC2 130 (hereinafter referred to as a “second target voltage”). Diagram (d) of FIG. 6 indicates the voltage of the input side LS2 of the FDC2 130. Diagram (e) of FIG. 6 indicates the output from the FDC2 130. Diagram (f) of FIG. 6 indicates a voltage command of the FDC1 120, i.e., a target voltage VT1 of the input side LS1 of the FDC1 120 (hereinafter referred to as a “first target voltage”). Diagram (g) of FIG. 6 indicates the voltage of the input side LS1 of the FDC1 120, and diagram (h) of FIG. 6 indicates the output from the FDC1 120.

Step 340A shown in FIG. 5 is described with reference to FIG. 6.

When the fuel cell unit 110 is to be started, the input side LS2 of the FDC2 130 is connected to the output side ND of the fuel cell unit 110 (step 341).

In other words, as illustrated in diagram (a) of FIG. 6, upon receiving a “high” logic level of start command through the input terminal IN1 at the initial stage t0, the controller 150 turns on the main switching unit 170 using the first switch signal S1 to interconnect the input side LS2 of the FDC2 130 and the output side ND of the fuel cell unit 110. In this case, the controller 150 may also turn on the sub-switching unit 220 using the second switch signal S2.

After step 341, the boosting operation of the FDC1 120 is held in a standby state, and the stepping-down operation of the FDC2 130 is performed until the voltage VL2 of the input side LS2 of the FDC2 130 reaches the second target voltage VT2 (steps 342 and 343).

In other words, after step 341, the boosting operation of the FDC1 120 is held in a standby state, and the stepping-down operation of the FDC2 130 is performed (step 342). After step 342, whether the voltage VL2 of the input side LS2 of the FDC2 130 has reached the second target voltage VT2 is determined (step 343). If the voltage VL2 of the input side LS2 of the FDC2 130 has not reached the second target voltage VT2, step 342 is continuously performed.

For example, step 342 is performed until the level of the voltage VL2 of the input side LS2 of the FDC2 130 shown in diagram (d) of FIG. 6 reaches the level L1 of the second target voltage VT2 shown in diagram (c) of FIG. 6.

After the voltage VL2 of the input side reaches the second target voltage VT2, a process desired for generation of power by the fuel cell unit 110 is performed until the first voltage reaches the second target voltage VT2 and the fuel cell unit 110 enters a state capable of generating power (steps 344 to 346).

In other words, after the voltage VL2 of the input side reaches the second target voltage VT2, a process desired for generation of power by the fuel cell unit 110 is performed (step 344). For example, as a process desired for generation of power by the fuel cell unit 110, hydrogen and oxygen may be supplied to the fuel cell unit 110. To this end, the BOP 230 may be driven. According to the embodiment, the BOP 230 may be driven using the voltage stepped down by the FDC2 130. As shown in diagram (e) of FIG. 6, power may be supplied from the FDC2 130 to the BOP 230 during a time period PD1 until a time point t2 at which the second target voltage VT2 shown in diagram (c) of FIG. 6 becomes zero and thus the FDC2 130 is stopped.

After step 344, whether the first voltage shown in diagram (b) of FIG. 6 has reached the level L1 of the second target voltage VT2 shown in diagram (c) of FIG. 6 is determined (step 345). If the first voltage has not reached the level L1 of the second target voltage VT2, step 344 is continuously performed. However, if the first voltage shown in diagram (b) of FIG. 6 has increased steadily until a time point t1 and thus has reached the level L1 of the second target voltage VT2, whether the fuel cell unit 110 is in a state capable of generating power is determined (step 346).

After the fuel cell unit enters the state capable of generating power, the operation of the FDC2 130 is stopped when the first voltage reaches the first target voltage VT1 of the input side LS1 of the FDC1 120 (steps 347 and 348).

In other words, when the fuel cell unit enters the state capable of generating power, the operation of the FDC2 130 is stopped (step 347). After the first voltage shown in diagram (b) of FIG. 6 continuously rises until the first time point t1, if the first voltage is maintained at the level L1 of the second target voltage VT2 from the first time point t1 to the second time point t2, the fuel cell unit 110 is determined to enter the state capable of generating power, and the operation of the FDC2 130 is stopped.

After step 347, whether the first voltage shown in diagram (b) of FIG. 6 has reached the level L2 of the first target voltage VT1 shown in diagram (f) of FIG. 6 of the input side LS1 of the FDC1 120 is determined (step 328). The first voltage shown in diagram (b) of FIG. 6 may rise steadily from the second time point t2 and may reach the level L2 of the first target voltage VT1 at a third time point t3. In this case, the FDC1 120, which is held in a boost standby state, may boost the first voltage shown in diagram (b) of FIG. 6 using the first target voltage VT1 shown in diagram (f) of FIG. 6. Thereafter, because the fuel cell unit 110 is capable of supplying power to the BOP 230 by itself, the main switching unit 170 is turned off at a fourth time point t4 (step 349). In other words, if the first voltage reaches the first target voltage, connection between the input side LS2 of the FDC2 130 and the output side ND of the fuel cell unit 110 is interrupted (step 349).

According to the embodiment, in consideration of measurement errors of the voltages VT1 and VT2, the level L2 of the first target voltage VT1 may be set to be higher than the level L1 of the second target voltage VT2. For example, the first level L1 may be set to 350 V, and the second level L2 may be set to 370 V. However, the embodiments are not limited to any specific value of each of the first and second levels L1 and L2.

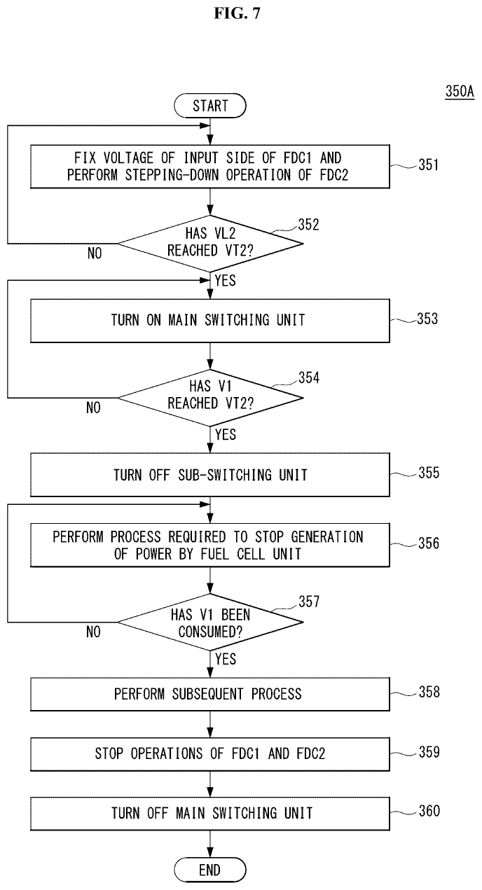

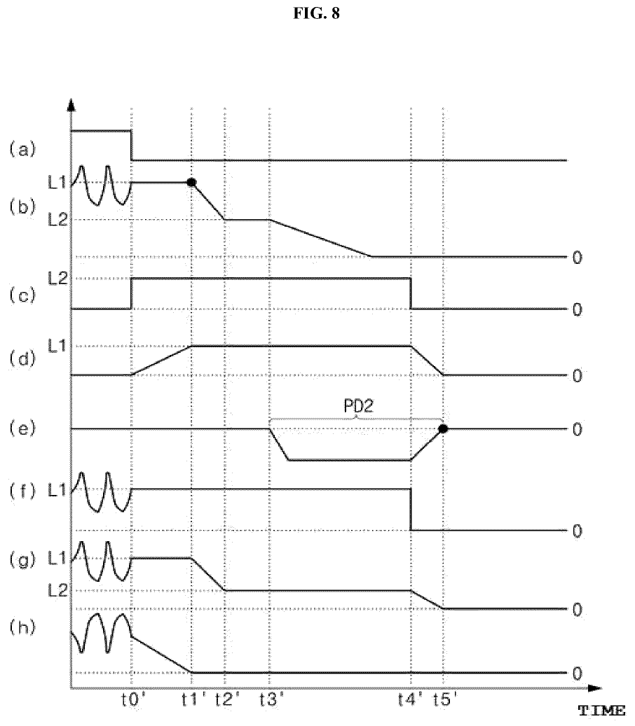

FIG. 7 is a flowchart explaining an embodiment 350A of step 350 shown in FIG. 4. FIG. 8 includes waveform diagrams explaining step 350A shown in FIG. 7. Diagram (a) of FIG. 8 indicates a stop command. Diagram (b) of FIG. 8 indicates a first voltage. Diagram (c) of FIG. 8 indicates a voltage command of the FDC2 130, i.e., a target voltage VT2 of the input side LS2 of the FDC2 130 (hereinafter referred to as a “second target voltage”). Diagram (d) of FIG. 8 indicates the voltage of the input side LS2 of the FDC2 130. Diagram (e) of FIG. 8 indicates the output from the FDC2 130. Diagram (f) of FIG. 8 indicates a voltage command of the FDC1 120, i.e., a target voltage VT1 of the input side LS1 of the FDC1 120 (hereinafter referred to as a “first target voltage”). Diagram (g) of FIG. 8 indicates the voltage of the input side LS1 of the FDC1 120, and diagram (h) of FIG. 8 indicates the output from the FDC1 120.

Step 350A shown in FIG. 7 is described with reference to FIG. 8.

When the fuel cell unit 110 is to be stopped, the voltage VL1 of the input side LS1 of the FDC1 120 is fixed, and the stepping-down operation of the FDC2 130 is performed until the voltage VL2 of the input side LS2 of the FDC2 130 reaches the second target voltage VT2 (steps 351 and 352).

In other words, as illustrated in diagram (a) of FIG. 8, upon receiving a “low” logic level of stop command through the input terminal IN1 at the initial stage t0′, the controller 150 fixes the voltage VL1 of the input side LS1 of the FDC1 120, and performs the stepping-down operation of the FDC2 130 (step 351). After step 351, whether the voltage VL2 of the input side LS2 of the FDC2 130 has reached the second target voltage VT2 is determined (step 352).

If the voltage VL2 of the input side LS2 of the FDC2 130 has reached the second target voltage VT2, the input side LS1 of the FDC2 130 and the output side ND of the fuel cell unit 110 are connected to each other (step 353). In other words, at a first time point t1′ at which the voltage VL2 of the input side LS2 of the FDC2 130 shown in diagram (d) of FIG. 8 reaches the level L2 of the second target voltage VT2 shown in diagram (c) of FIG. 8, the main switching unit 170 is turned on in order to interconnect the input side LS1 of the FDC2 130 and the output side ND of the fuel cell unit 110 (step 353).

After step 353, when the first voltage reaches the second target voltage, connection between each of the FDC1 120 and the FDC2 130 and the cell stack 210 is interrupted (steps 354 and 355). In other words, after step 353, whether the first voltage shown in diagram (b) of FIG. 8 has reached the level L2 of the second target voltage VT2 shown in diagram (c) of FIG. 8 is determined (step 354). If the first voltage shown in diagram (b) of FIG. 8 has reached the second target voltage VT2, the sub-switching unit 220 is turned off in order to interrupt connection between each of the FDC1 120 and the FDC2 130 and the cell stack 210 (step 355).

Thus, power may be supplied from the FDC2 130 to the BOP 230 during a time period PD2 from a third time point t3′ to a fifth time point t5′ at which the main switching unit 170 is turned off.

After step 355, a process desired to stop generation of power by the fuel cell unit 110 is performed until the first voltage is consumed (steps 356 and 357). In other words, after step 355, a process desired to stop generation of power by the fuel cell unit 110, e.g., interruption of supply of oxygen to the fuel cell unit 110, may be performed (step 356). After step 356, whether the first voltage has been consumed is determined. If the first voltage has not been consumed, the process proceeds to step 356 (step 357).

Referring to FIG. 8B, the first voltage may be continuously consumed from the third time point t3′ at which power is supplied from the FDC2 130 to the BOP 210.

If the first voltage has been consumed, a subsequent process for stopping generation of power by the fuel cell unit 110 is performed (step 358). For example, a subsequent process of discharging remaining product water or the like, which is a byproduct generated during generation of power by the cell stack 210, may be performed.

After step 358, the operations of the FDC1 120 and the FDC2 130 are stopped (step 359).

After step 359, the main switching unit 170 may be turned off in order to interrupt connection between the input side LS2 of the FDC2 130 and the output side ND of the fuel cell unit 110 (step 360).

In addition, when the fuel cell apparatus 100 or 100A according to the embodiment is generating power, rather than being started or stopped, the FDC2 130 may be stopped, and the FDC1 120 may boost the first voltage and supply the boosted voltage to the battery 140. For example, the FDC1 120 may boost the first voltage of 400 V to a level equal to the level (800 V) of the voltage stored in the battery 140.

Hereinafter, a fuel cell apparatus according to a comparative example and the fuel cell apparatus according to the embodiment is described with reference to the accompanying drawings.

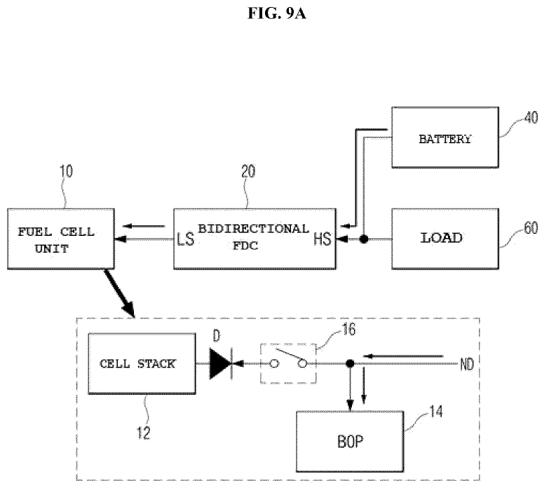

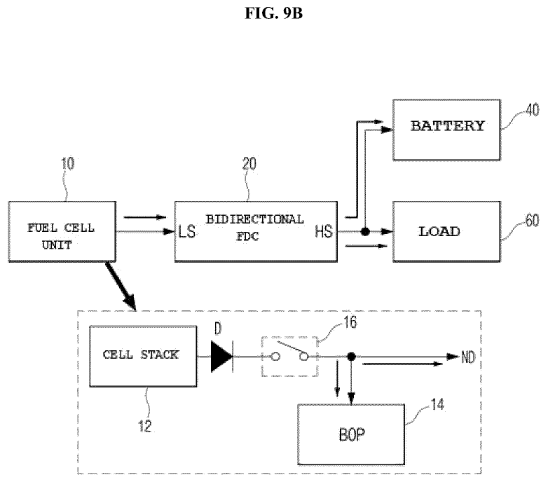

FIGS. 9A and 9B are block diagrams of a fuel cell apparatus according to a comparative example.

The fuel cell apparatus according to the comparative example shown in FIGS. 9A and 9B includes a fuel cell unit 10, a bidirectional FDC 20, a battery 40, and a load 60. In addition, the fuel cell unit 10 includes a cell stack 12, a diode D, a BOP 14, and a switch 16.

The fuel cell unit 10, the battery 40, the load 60, the cell stack 12, the diode D, the BOP 14, and the switch 16 perform the same functions as the fuel cell unit 110, the battery 140, the load 160, the cell stack 210, the diode D, the BOP 230, and the sub-switching unit 220 shown in FIGS. 1 and 2, respectively, and thus a duplicate description thereof has been omitted.

Hereinafter, the operation of the fuel cell apparatus shown in FIGS. 9A and 9B has been described with reference to the accompanying drawings.

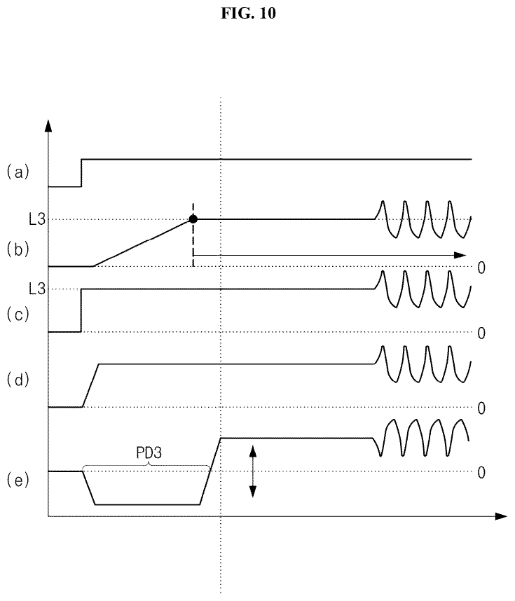

FIG. 10 includes timing diagrams explaining the start operation of the fuel cell apparatus according to the comparative example. Diagram (a) of FIG. 10 indicates a start command. Diagram (b) of FIG. 10 indicates a stack voltage. Diagram (c) of FIG. 10 indicates the target voltage of the bidirectional FDC 20. Diagram (d) of FIG. 10 indicates the voltage of an input side LS of the bidirectional FDC 20, and diagram (e) of FIG. 10 indicates the output from the bidirectional FDC 20.

As shown in diagram (a) of FIG. 10, when the start command changes from a “low” logic level to a “high” logic level, the switch 16 is turned on. In this case, the bidirectional FDC 20 operates as a buck converter. Therefore, as shown in FIG. 9A, the voltage having a high level (800 V) stored in the battery 40 may enter a high-voltage side HS of the bidirectional FDC 20, and may then be stepped down to 400 V. Thereafter, the stepped-down voltage of 400 V may be supplied to BOP 14 as power through the low-voltage side LS. In this way, the bidirectional FDC 20 may supply power to the BOP 14 during a time period PD3 shown in diagram (e) of FIG. 10. In this case, the BOP 14 is driven, and hydrogen and oxygen are supplied to the cell stack 12. Accordingly, as shown in diagram (b) of FIG. 10, the stack voltage may rise to the level L3 of the target voltage shown in diagram (c) of FIG. 10. For example, the level L3 may be equal to the above-described level L2.

Thereafter, as shown in FIG. 9B, the bidirectional FDC 20 may operate as a boost converter, rather than operating as a buck converter, thereby boosting the stack voltage of 400 V to 800 V and supplying the boosted voltage to the battery 40.

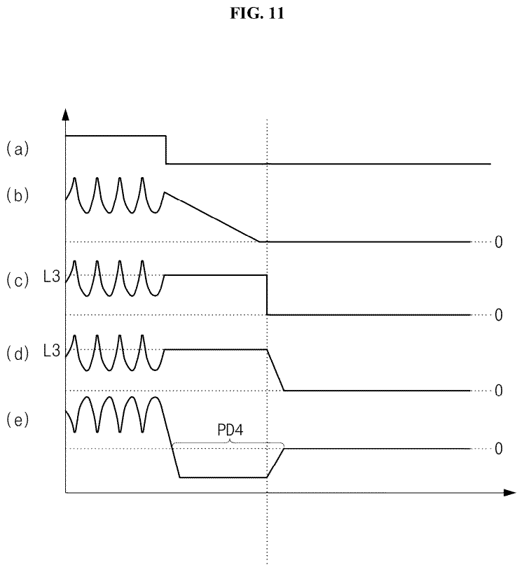

FIG. 11 includes timing diagrams explaining the stop operation of the fuel cell apparatus according to the comparative example. Diagram (a) of FIG. 11 indicates a stop command. Diagram (b) of FIG. 11 indicates the stack voltage. Diagram (c) of FIG. 11 indicates the target voltage of the bidirectional FDC 20. Diagram (d) of FIG. 11 indicates the voltage of the input side LS of the bidirectional FDC 20, and diagram (e) of FIG. 11 indicates the output from the bidirectional FDC 20.

As shown in diagram (a) FIG. 11, the switch 16 is turned off in response to a “high” logic level of stop command. In this case, the bidirectional FDC 20 operates as a buck converter. Therefore, as shown in FIG. 9A, the voltage having a high level (800 V) stored in the battery 40 enters the high-voltage side HS of the bidirectional FDC 20, and then is stepped down to 400 V. Thereafter, the stepped-down voltage of 400 V is supplied to the BOP 14 as power through the low-voltage side LS. In this way, the bidirectional FDC 20 may supply power to the BOP 14 during a time period PD4 shown in diagram (e) of FIG. 11. In this case, the BOP 14 is driven, and supply of oxygen to the cell stack 12 is interrupted. Accordingly, as shown in diagram (b) of FIG. 11, the stack voltage is consumed, and a subsequent operation of the BOP 14 is performed. Thereafter, the bidirectional FDC 20 is stopped.

The bidirectional FDC 20 of the fuel cell apparatus according to the comparative example described above is of an insulated type. The insulated type of bidirectional FDC 20 is very difficult to develop and thus can hardly be commercialized. Further, the bidirectional FDC 20 functions as a buck converter only when the fuel cell unit is started or stopped, and the amount of power desired at this time is very small. This is because the output from the bidirectional FDC 20 is used only to drive the BOP 14 at the time of start or stop. Nevertheless, if the bidirectional FDC 20, which is expensive, is used, manufacturing costs of the fuel cell apparatus may increase.

In contrast, in the case of the fuel cell apparatus according to the embodiment, the insulated unidirectional boost converter 120 and the insulated unidirectional buck converter are used, or the insulated unidirectional boost converter 120 and the non-insulated unidirectional buck converter 130 are used. Although the embodiment uses two unidirectional converters, because the unidirectional converter is much cheaper than the bidirectional FDC 20, manufacturing costs may be reduced compared to the fuel cell apparatus according to the comparative example.

In addition, in the embodiment, the FDC1 120, which functions only as a boost converter, and the FDC2 130, which functions only as a buck converter, are used in accordance with the amount of power desired. Since the FDC1 120 is of an insulated type, sufficient insulation resistance may be secured even when the plurality of fuel cell units is connected in parallel, as shown in FIG. 3. For example, the total insulation resistance RT of the fuel cell apparatus shown in FIG. 3 is calculated as shown in Equation 1 below.

$$RT = {( \frac{1}{R 1} + \frac{1}{R 2} + … + \frac{1}{RN} )}^{- 1} \qquad [ Equation 1 ]$$

R1, R2, and RN represent the insulation resistances of the first, second, and N^{th} fuel cell units 112, 114, and 116 shown in FIG. 3, respectively.

The fuel cell apparatus 100 or 100A according to the embodiment described above may be applied to vehicles, aircraft, ships, stationary power generation systems, and the like, but the disclosure is not limited thereto.

As is apparent from the above description, a fuel cell apparatus and a method of controlling the same according to embodiments may reduce manufacturing costs and may secure sufficient insulation resistance.

However, the effects achievable through the disclosure are not limited to the above-mentioned effects, and other effects not mentioned herein should be clearly understood by those having ordinary skill in the art from the above description.

The above-described various embodiments may be combined with each other without departing from the scope of the present disclosure unless they are incompatible with each other.

In addition, for any element or process that is not described in detail in any of the various embodiments, reference may be made to the description of an element or a process having the same reference numeral in another embodiment, unless otherwise specified.

While the present disclosure has been particularly shown and described with reference to embodiments thereof, these embodiments are only proposed for illustrative purposes, and do not restrict the present disclosure, and it should be apparent to those having ordinary skill in the art that various changes in form and detail may be made without departing from the essential characteristics of the embodiments set forth herein. For example, respective configurations set forth in the embodiments may be modified and applied. Further, differences in such modifications and applications should be construed as falling within the scope of the present disclosure as defined by the appended claims.

What is claimed is:

1. A fuel cell apparatus, comprising:
a fuel cell unit configured to generate a first voltage;
a battery configured to store a second voltage having a higher level than the first voltage;
a first voltage level conversion unit configured to boost the first voltage and supply the boosted voltage to the battery in response to a first control signal;
a second voltage level conversion unit configured to step down the second voltage and supply the stepped-down voltage to the fuel cell unit in response to a second control signal; and
a controller configured to generate the first control signal and the second control signal in response to a start command or a stop command.

2. The fuel cell apparatus according to claim 1, wherein the first voltage level conversion unit comprises an insulated unidirectional boost converter.

3. The fuel cell apparatus according to claim 2, wherein the second voltage level conversion unit comprises an insulated unidirectional buck converter.

4. The fuel cell apparatus according to claim 2, wherein the second voltage level conversion unit comprises a non-insulated unidirectional buck converter.

5. The fuel cell apparatus according to claim 4, further comprising a main switching unit configured to interrupt or allow electrical connection between the second voltage level conversion unit and the fuel cell unit in response to a first switching signal.

6. The fuel cell apparatus according to claim 1, wherein the first voltage level conversion unit comprises a first input side connected to the fuel cell unit and a first output side connected to the battery, and
wherein the second voltage level conversion unit comprises a second input side connected to the fuel cell unit and a second output side connected to the battery.

7. The fuel cell apparatus according to claim 1, wherein the fuel cell unit comprises first to N^{th} fuel cell units configured to respectively generate 1-1^{st} to 1-N^{th} voltages,
wherein the controller generates 1-1^{st} to 1-N^{th} control signals as the first control signal and generates 2-1^{st} to 2-N^{th} control signals as the second control signal,
wherein the first voltage level conversion unit includes 1-1^{st} to 1-N^{th} voltage level conversion units,
wherein the second voltage level conversion unit includes 2-1^{st} to 2-N^{th} voltage level conversion units,
wherein a 1-n^{th} voltage level conversion unit boosts a 1-n^{th} voltage and supplies the boosted voltage to the battery in response to a 1-n^{th} control signal, and
wherein a 2-n^{th} voltage level conversion unit steps down the second voltage and supplies the stepped-down voltage to an n^{th} fuel cell unit in response to a 2-n^{th} control signal.

8. The fuel cell apparatus according to claim 7, wherein the controller determines a number of fuel cell units to be started or stopped simultaneously among the first to N^{th} fuel cell units in accordance with an insulation resistance value.

9. The fuel cell apparatus according to claim 7, wherein the n^{th} fuel cell unit comprises:
a cell stack configured to generate a 1-n^{th} voltage;
a peripheral auxiliary device configured to aid in operation of the cell stack;
a sub-switching unit connected between each of the 1-n^{th} and 2-n^{th} voltage level conversion units and the cell stack, the sub-switching unit being configured to be switched in response to a 2-n^{th} switching signal; and
a diode including an anode connected to the cell stack and a cathode connected to the sub-switching unit.

10. The fuel cell apparatus according to claim 9, wherein the controller switches the sub-switching unit using the 2-n^{th} switching signal to stop or start the n^{th} fuel cell unit.

11. A method of controlling a fuel cell apparatus comprising a fuel cell unit configured to generate a first voltage, a battery configured to store a second voltage having a higher level than the first voltage, a first voltage level conversion unit configured to boost the first voltage and supply the boosted voltage to the battery, and a second voltage level conversion unit configured to step down the second voltage and supply the stepped-down voltage to the fuel cell unit, the method comprising:
determining whether to start the fuel cell unit or to stop the fuel cell unit;
starting the fuel cell unit using the second voltage level conversion unit upon determining to start the fuel cell unit; and
stopping the fuel cell unit using the second voltage level conversion unit upon determining to stop the fuel cell unit.

12. The method according to claim 11, wherein the fuel cell unit comprises:
a cell stack configured to generate the first voltage; and
a peripheral auxiliary device configured to aid in operation of the cell stack.

13. The method according to claim 12, wherein starting the fuel cell unit comprises:
connecting an input side of the second voltage level conversion unit to an output side of the fuel cell unit to start the fuel cell unit;
holding a boosting operation of the first voltage level conversion unit in a standby state;
performing a stepping-down operation of the second voltage level conversion unit until a voltage of the input side of the second voltage level conversion unit reaches a second target voltage;
performing a process for generation of power by the fuel cell unit after the voltage of the input side reaches the second target voltage and until the first voltage reaches the second target voltage and the fuel cell unit enters a state capable of generating power;
stopping an operation of the second voltage level conversion unit after the fuel cell unit enters the state capable of generating power and until the first voltage reaches a first target voltage of an input side of the first voltage level conversion unit; and
interrupting the connection between the input side of the second voltage level conversion unit and the output side of the fuel cell unit when the first voltage reaches the first target voltage.

14. The method according to claim 13, wherein stopping the fuel cell unit comprises:
fixing a voltage of the input side of the first voltage level conversion unit and performing the stepping-down operation of the second voltage level conversion unit until the voltage of the input side of the second voltage level conversion unit reaches the second target voltage to stop the fuel cell unit;
connecting the input side of the second voltage level conversion unit and the output side of the fuel cell unit to each other when the voltage of the input side of the second voltage level conversion unit reaches the second target voltage;
interrupting the connection between each of the first and second voltage level conversion units and the cell stack when the first voltage reaches the second target voltage;
performing a process to stop generation of power by the fuel cell unit until the first voltage is consumed;
performing a subsequent process to stop generation of power by the fuel cell unit when the first voltage is consumed;
stopping operations of the first and second voltage level conversion units; and
interrupting connection between the input side of the second voltage level conversion unit and the output side of the fuel cell unit.

15. A fuel cell apparatus comprising:
a fuel cell unit configured to generate a first voltage;
a battery configured to store a second voltage having a higher level than the first voltage;
a first voltage level conversion unit configured to boost the first voltage and supply the boosted voltage to the battery;
a second voltage level conversion unit configured to step down the second voltage and supply the stepped-down voltage to the fuel cell unit; and
a controller configured to:
determine whether to start the fuel cell unit or to stop the fuel cell unit;
start the fuel cell unit using the second voltage level conversion unit upon determining to start the fuel cell unit; and
stop the fuel cell unit using the second voltage level conversion unit upon determining to stop the fuel cell unit.

16. The fuel cell apparatus according to claim 15, wherein the fuel cell unit comprises:
a cell stack configured to generate the first voltage; and
a peripheral auxiliary device configured to aid in operation of the cell stack.

17. The fuel cell apparatus according to claim 16, further comprising a main switching unit configured to interrupt or allow electrical connection between the second voltage level conversion unit and the fuel cell unit in response to a first switching signal.

18. The fuel cell apparatus according to claim 17, wherein the controller is further configured to generate the first switching signal in response to determining to start or stop the fuel cell unit.

19. The fuel cell apparatus according to claim 18, wherein the controller is further configured to:
connect using the main switching unit an input side of the second voltage level conversion unit to an output side of the fuel cell unit to start the fuel cell unit;
hold a boosting operation of the first voltage level conversion unit in a standby state;
perform a stepping-down operation of the second voltage level conversion unit until a voltage of the input side of the second voltage level conversion unit reaches a second target voltage;
perform a process for generation of power by the fuel cell unit after the voltage of the input side reaches the second target voltage and until the first voltage reaches the second target voltage and the fuel cell unit enters a state capable of generating power;
stop an operation of the second voltage level conversion unit after the fuel cell unit enters the state capable of generating power and until the first voltage reaches a first target voltage of an input side of the first voltage level conversion unit; and
interrupt the connection between the input side of the second voltage level conversion unit and the output side of the fuel cell unit when the first voltage reaches the first target voltage.

20. The fuel cell apparatus according to claim 19, wherein the controller is further configured to:
fix a voltage of the input side of the first voltage level conversion unit and performing the stepping-down operation of the second voltage level conversion unit until the voltage of the input side of the second voltage level conversion unit reaches the second target voltage to stop the fuel cell unit;
connect using the main switching unit the input side of the second voltage level conversion unit and the output side of the fuel cell unit to each other when the voltage of the input side of the second voltage level conversion unit reaches the second target voltage;
interrupt the connection between each of the first and second voltage level conversion units and the cell stack when the first voltage reaches the second target voltage;
perform a process to stop generation of power by the fuel cell unit until the first voltage is consumed;
perform a subsequent process to stop generation of power by the fuel cell unit when the first voltage is consumed;
stop operations of the first and second voltage level conversion units; and
interrupt the connection between the input side of the second voltage level conversion unit and the output side of the fuel cell unit.
